(19) United States
(12) Patent Application Publication
(10) Pub. No.: US 2025/0007436 A1
(43) Pub. Date: Jan. 2, 2025

(54) METHOD FOR RECONFIGURING AN ELECTRIC MACHINE

(71) Applicant: ELDOR CORPORATION S.P.A., Orsenigo (Como) (IT)

(72) Inventors: Pasquale FORTE, Orsenigo (Como) (IT); Luca ZAI, Orsenigo (Como) (IT); Ruggero SECCIA, Orsenigo (Como) (IT); Javier Eduardo PEREIRA RIVAS, Orsenigo (Como) (IT)

(21) Appl. No.: 18/709,479

(22) PCT Filed: Nov. 10, 2022
(86) PCT No.: PCT/IB2022/060827

§ 371 Date: May 10, 2024

(30) Foreign Application Priority Data
Nov. 12, 2021 (IT) 102021000028772

(51) Int. Cl. H02P 23/00; H02P 25/18; H02P 29/66

(52) U.S. Cl. CPC H02P 23/0027; H02P 29/662; H02P 25/18

(57) ABSTRACT

Method for reconfiguring an electric machine including a rotor arranged to rotate with an angular speed (ω), the electric machine being arranged to pass from a first configuration (config₁) to a second configuration (config₂), the method comprising the steps of:
a) determining in real-time a real speed threshold (ω_{real_th}) depending on the current operating condition of the electric machine;
b) checking if the angular speed (ω) of the rotor is greater than said real speed threshold (ω_{real_th});
c) in positive case, no reconfiguration is performed from the first configuration (config₁);
d) in negative case:
   d.1) determining the current configuration of the electric machine;
   d.2) selecting a reconfiguring decision method;
   d.3) deciding whether to reconfigure the electric machine or not and, in positive case, reconfiguring the electric machine.

The present invention relates to the control of electro-vehicles or hybrid electro-vehicles with an integrated reconfigurable system.

In particular, the present invention relates to a method for reconfiguring an electric machine, said electric machine being preferably hosted on an electric vehicle.

An electric machine is a machine that comprises a rotor whose rotation generates a back electromotive force (BEMF). An inverter usually feeds the electric machine. In regular electric machines the BEMF force has a value always below or at least equal to the one of the supply voltage of the electric machine, because the inverter is controlled to avoid the opposite situation.

In a zone where the e-machine would naturally generate a BEMF that exceeds the supply voltage, the inverter can never be switched off because otherwise dangerous side effects as here below detailed would arise.

The back electromotive force depends, among other features, on the angular speed ω of the rotor. For this reason, there exists a threshold value ωₜₕ of such angular speed above which the back electromotive force exceeds the supply voltage. Such threshold value ωₜₕ depends on the supply voltage, the current in the rotor, if present, and the temperature of the magnets constrained to the rotor.

Documents WO 2020/194230, WO 2021/099894 and WO 2021/079332 discloses recent electric machines, in particular three-phases electric machines, which are designed to adopt different electrical configurations based on different connections and/or topology of the three-phases, in order to achieve different performances according to different uses of the electric machine itself.

A process for reconfiguring (namely the switching between one configuration and another one) an electric machine, however, needs the inverter to be disconnected for a few moments, so rendering quite dangerous to perform the reconfiguration at speeds higher that the threshold value.

For this reason, the reconfiguration is usually done at predetermined and fixed values of the angular speed of the rotor of the electric machine, said fixed values being predetermined in advance and in a very precautionary way, namely by selecting values with the machine operating in the worst-case scenario. Usually, these fixed values are set during a design phase of the electric machine and they are further tuned during calibration testing of the electric machine.

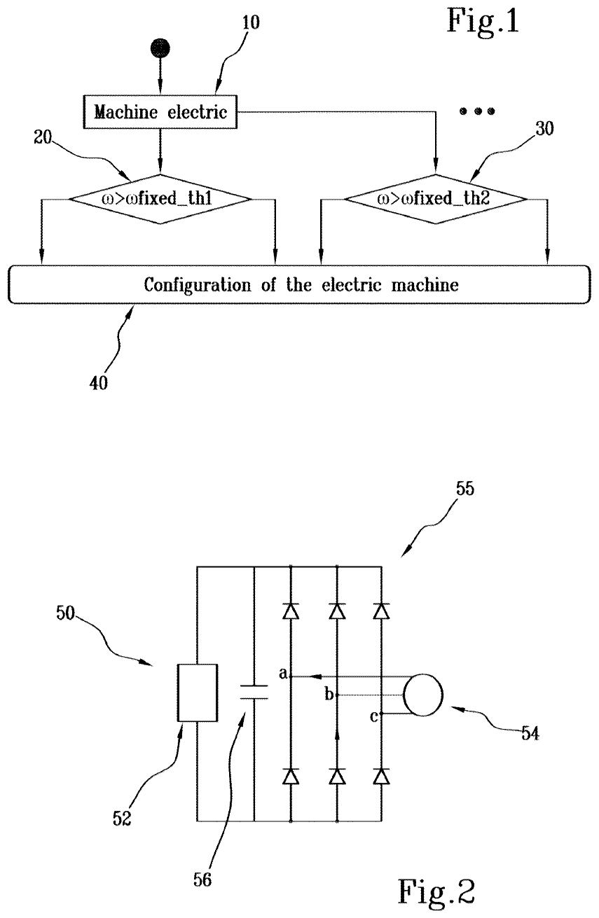

A typical method for a state-of-the-art reconfiguring process is performed according to the steps shown in the block diagram of FIG. 1.

Document JPH053694A discloses an example of such known method.

In a first step 10, the current configuration of the electric machine is determined. Then, at step 20 the angular speed ω of the rotor of the electric machine is acquired and compared with a fixed threshold ω_{fixed_th1} and finally, based on the result of such comparison, in a further step 40 a reconfiguration decision and reconfiguration operation is carried out. To be noted that the angular speed ω of the rotor of the electric machine can be compared with one or more fixed threshold values, as in step 30, and the reconfiguration logic performed at step 40 can be arbitrarily complex—using hysteresis, prediction or deterministic equations involving other parameters—but the speed thresholds in which relies on are always fixed and determined in advance.

This approach of setting the fixed thresholds in advance has been generally used in reconfigurable systems since their creation, and it has been especially applied to trains, turbines or drilling machines.

On the contrary, in electric or hybrid vehicles the limitations of this simplified approach can be evident in the following aspects.

In every system that involves an electric machine, power electronics and a voltage supply, there is a phenomenon known as UGO (Uncontrolled Generator Operation) that happens when the inverter that feeds the electric machine is erroneously switched off at values of the angular speed ω exceeding the threshold value ωₜₕ, so that the electric machine voltage generated by the rotation of the rotor (BEMF) exceeds the value of the supply voltage.

This is a negative situation that should always be avoided.

FIG. 10 shows a graph wherein a first line 400 representing the voltage supply of an electric machine intersects a second line 402 representing the induced voltage produced by the electric machine, this intersection occurring at a certain speed ω of the rotor.

For example, in permanent magnet electric motors or wrapped rotors, the voltage induced by the presence of magnets or magnetizing current, which is proportional to the operational speed of the rotor, can exceed the voltage supply.

When the inverter is turned off and the voltage induced by the electric machine is higher than the supply voltage, a power flow from the wheels of the vehicle to the supply voltage is generated. This energy flow corresponds to an uncontrolled braking of the vehicle, which may be dangerous for the users inside the vehicle and people outside the vehicle.

The flow of power goes from the electric machine towards the voltage supply, and if this phenomenon is not properly handled, it can destroy the electric machine, the inverter or the battery.

FIG. 2 shows a supply circuit 50 for an electric machine wherein an UGO phenomenon can happen. The circuit 50 includes a supply voltage generator 52, such a battery, and an electric machine such as a three-phases motor 54, connected with three phases a, b and c to the supply voltage generator 52 through an inverter, of which only the recirculation diodes 55 are shown, and a condenser 56 placed in parallel to the supply voltage generator 52.

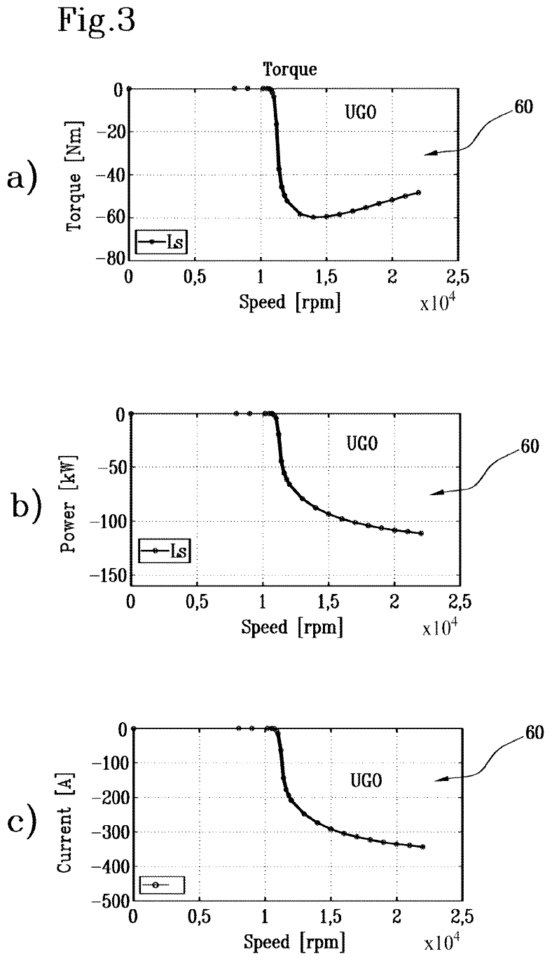

The uncontrolled power flow that goes from the electric machine 54 towards the supply voltage generator 52 implies also a braking torque to the electric machine shaft, that grows rapidly depending on the rotor speed and the design characteristics of the electric machine. These effects are shown in the FIGS. 3a-3c.

FIG. 3a shows a graph of the rotor speed vs. the shaft torque; FIG. 3b shows a graph of the rotor speed vs. the power regenerated during the unwanted braking and FIG. 3c shows a graph of the rotor speed vs. the current flowing in the electric machine 54, in case of erroneous switching off of the inverter when the voltage induced by the electric machine is higher than the supply voltage. An area 60 indicates where the UGO phenomenon happens.

In the situation of switching off of the inverter, UGO and all the related consequences can arise because, as said, a reconfiguration process includes turning off the inverter.

It is therefore evident that a threshold on the rotor speed must be applied in order to avoid performing a reconfiguration in situations when an UGO phenomenon can arise. This threshold condition can be easily applied considering the following equation:

V_{supply}>Kᵥω

where V_{supply} is the supply voltage, Kᵥ is a voltage constant which depends on electric machine parameters and ω is the speed of the rotor of the electric machine.

Usually, Kᵥ is determined in advance during a design and calibration phase of the electric machine, hence, the equation becomes:

$$ω < {V}_{supply} / {K}_{v}$$

Therefore, the threshold becomes a fixed value:

$${ω}_{th} = {V}_{supply} / {K}_{v}$$

because V_{supply} and Kᵥ are considered as two constant values.

The problem of this approach is that in reality both V_{Supply} and Kᵥ are two parameters which can vary during electric machine operation, therefore, applying a fixed threshold to the angular speed is not the more convenient choice, as disclosed here below.

For example, in the case of a permanent magnet electric machine, Kᵥ varies as a function of the magnet and windings temperature. In other cases, as a wounded rotor electric machine, Kᵥ varies also as a function of the current circulating through the rotor besides the already mentioned magnet and windings temperature.

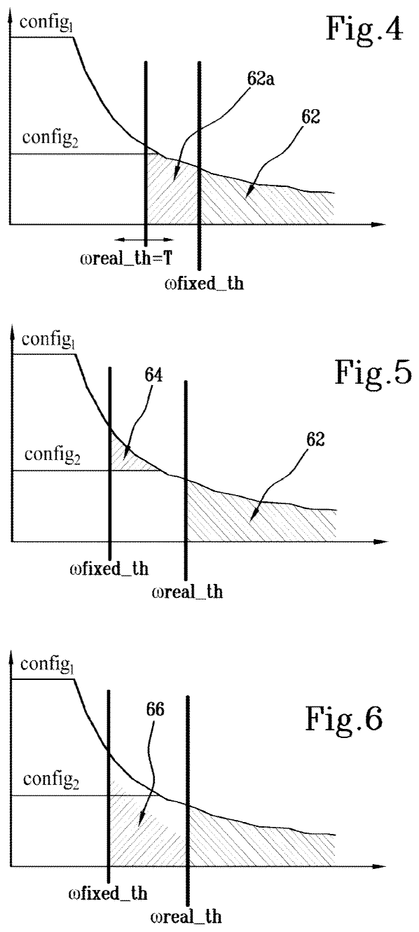

FIG. 4 shows a first graph of a fixed threshold ω_{fixed_th} applied to an electric machine that turns off the inverter to pass from a first configuration config₁ to a second configuration config₂. In an UGO area 62 a UGO phenomenon occurs, therefore, if the angular speed of the rotor is below the fixed threshold ω_{fixed_th} but still in the UGO area 62 (in particular, in a fault area 62a), the reconfiguration from the first configuration config₁ to the second configuration config₂ is performed, but a problem to the electric machine occurs. It is evident that this situation should not happen.

In fact, if the real threshold ω_{real_th} of the angular speed of the rotor that varies in real-time manner and which should not be exceeded to perform a safe reconfiguration from the first configuration config₁ to the second configuration config₂, is lower than the fixed threshold ω_{fixed_th}, then the electric machine carries out the reconfiguration from the first configuration config₁ to the second configuration config₂ in the dangerous UGO area 62, thus generating all the above-mentioned effects.

In order to solve the above-mentioned problem, the worst possible operating condition should be considered, wherein the fixed threshold ω_{fixed_th} is put equal to the ratio between the supply voltage and the voltage constant taken in the worst possible condition.

FIG. 5 shows a second graph of the fixed threshold ω_{fixed_th} applied to an electric machine that turns off the inverter to pass from a first configuration config₁ to a second configuration config₂. As already mentioned, the fixed threshold set as worst-case scenario generates a a low-performance area 64 in which a loss in performance and comfort occurs, due to an early reconfiguration.

A torque drop is evident when the reconfiguration occurs at a maximum torque request and before the ω_{fixed_th}, thus producing a reduced performance for acceleration, an unpredictable performance for the driver when the electric machine is applied to a vehicle because the torque drop depends on the current state of the electric machine. Furthermore, comfort problems also occur, this being particularly important considering that current battery electric vehicles have no torque drop at all.

FIG. 6 shows a third graph of a fixed threshold ω_{fixed_th} applied to an electric machine. As already mentioned, the fixed threshold set as worst-case scenario generates an early-reconfiguration area 66 in which a loss in system efficiency occurs, due to an early reconfiguration. In the early-reconfiguration area 66 the first configuration config₁ is more efficient than the second configuration config₂, but due to the fixed threshold ω_{fixed_th}, the electric machine is forced to changed.

All the above situations show that a dangerous or inefficient operation of the electric machine can happen with a fixed threshold on the angular speed of the rotor.

There is therefore the need to provide a method for reconfiguring an electrical machine which allow obtaining the necessary safety in a simple manner, without losing performance, comfort and efficiency.

These and other objects are fully achieved by virtue of a method for reconfiguring an electrical machine having the characteristics defined in independent claim 1.

Preferred embodiments of the invention are specified in the dependent claims, whose subject-matter is to be understood as forming integral or integrating part of the present description.

Further characteristic and advantages of the present invention will become apparent from the following description, provided merely by way of non-limiting example, with reference to the attached drawings, in which:

FIG. 1 is a block diagram of the step of a reconfiguration method of the prior art;

FIG. 2 shows a circuit of an electric axle wherein an UGO phenomenon can happen;

FIG. 3a shows a graph of the rotor speed vs. the shaft torque of an electric machine during UGO phenomenon;

FIG. 3b shows a graph of the rotor speed vs. the power regenerated to the power supply during UGO phenomenon;

FIG. 3c shows a graph of the rotor speed vs. the current flowing in the electric machine during UGO phenomenon;

FIG. 4 shows a first graph of a fixed threshold ω_{fixed_th} applied to an electric machine;

FIG. 5 shows a second graph of the fixed threshold ω_{fixed_th} applied to an electric machine;

FIG. 6 shows a third graph of a fixed threshold ω_{fixed_th} applied to an electric machine;

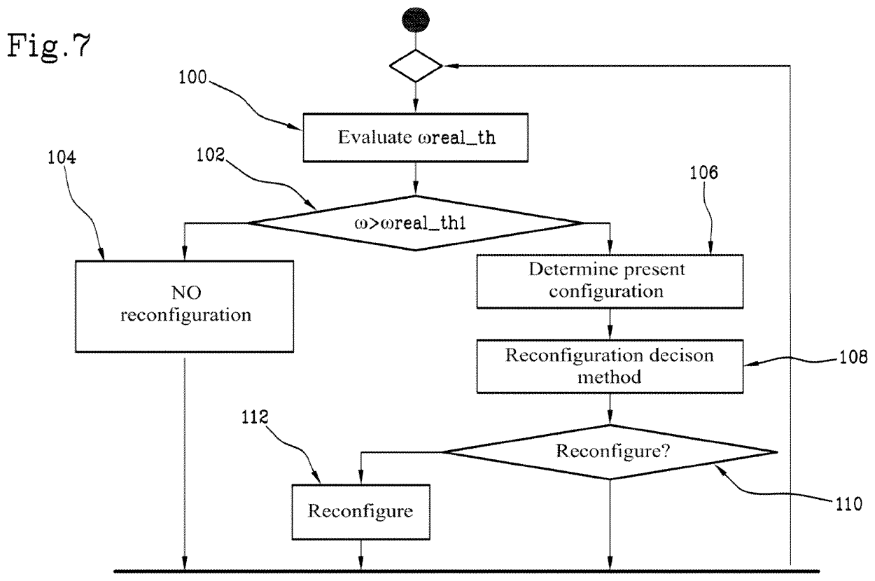

FIG. 7 is a block diagram of the steps of a reconfiguration method according to the present invention;

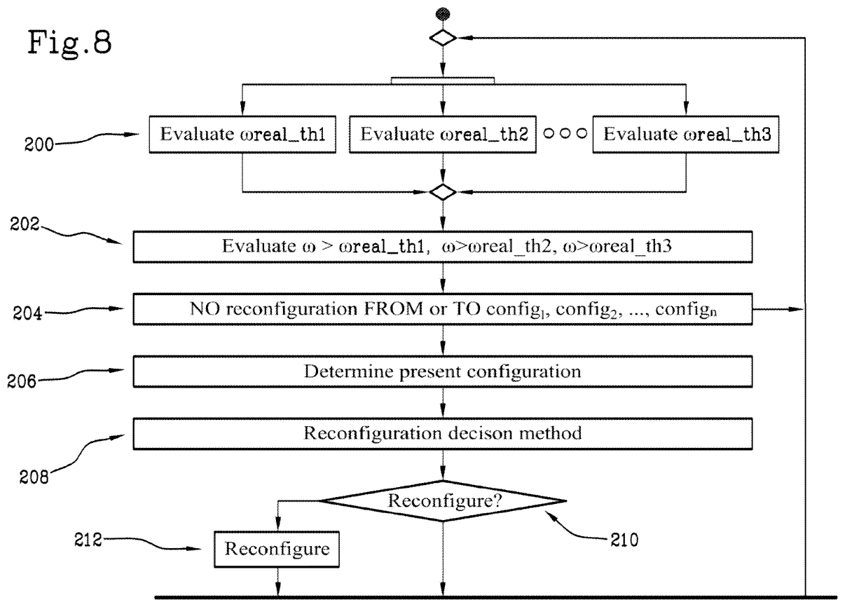

FIG. 8 shows a block diagram of the steps of the reconfiguration method executed in parallel,

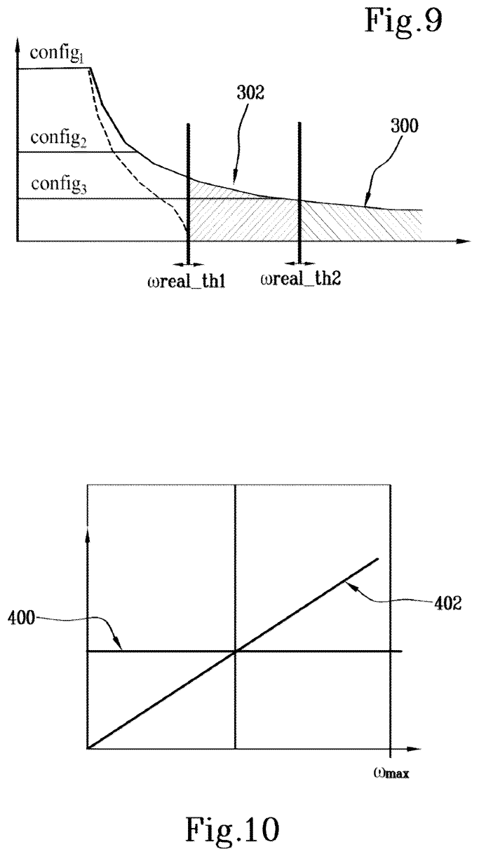

FIG. 9 shows a graph of variable thresholds ω_{real_th} applied to an electric machine with three possible configurations;

FIG. 10 shows a graph with a first line representing the voltage supply of an electric machine intersecting a second line representing the induced voltage produced by the electric machine.

With reference to the drawings, FIG. 7 is a block diagram of the steps of a reconfiguring method according to the present invention.

The method according to the present invention is applied to an electric machine including a rotor, arranged to rotate at a certain angular speed ω, said rotor including a magnet.

In a first step 100, the real speed threshold ω_{real_th} is evaluated (or determined) in real-time manner as detailed here below, then, in step 102, it is checked if a current angular speed ω is greater than the real speed threshold ω_{real_th}.

In positive case, in step 104 there is no reconfiguration.

In negative case, in step 106, the current configuration of the electric machine is determined in a manner per sé known, then, in step 108, a reconfiguring decision method per sé known is selected. After that, in step 110, it is decided whether to reconfigure the electric machine or not (according to predetermined selection strategies based on a control logic of the electric machine) and, in positive case, in step 112, the reconfiguration of the electric machine is performed.

The determination in real-time manner of the real speed threshold ω_{real_th} of step 100 is done by performing a temperature estimation of the magnet of the rotor and then applying deterministic equations to such temperature estimation, by performing a predictive logic process or by applying an analytical model of the full electric machine, in manners per se known.

In particular, the real speed threshold ω_{real_th} is function not only of the temperature of the magnet but also of the supply voltage and, if present, of the current in the rotor. The supply voltage and the current in the rotor can be measured using respective sensors.

In a more specific way, the real speed threshold ω_{real_th} can be evaluated with the following relationship:

$$[ [ {λ}_{mo} + α ( T - {T}_{0} ) ] + {N}_{rot} {N}_{stat} {I}_{rot} ] {ω}_{{real}_{th}} = \frac{{V}_{dc}}{\sqrt{3}} + 2 {V}_{diode} + {Δ V}_{stat}$$

where:
   λₘₒ and T₀ are respectively a predetermined reference magnetic flux and a respective reference temperature, evaluated by test or simulation;
   α is the thermal coefficient of the permanent magnet material, and it is given by its producer through datasheet or evaluated with test;
   T is the magnet temperature which varies during electric machine operation, and it is estimated or measured with sensors;
   Nᵣₒₜ and Nₛₜₐₜ are respectively the number of turns of the windings on the rotor, if present, and the number of turns of the windings on the stator, predetermined during a design phase;
   Iᵣₒₜ is the current flowing in the rotor windings, if present, measured with sensors;
   V_{dc} is the voltage of the supply, which varies during electric machine operation and is measured with sensor;
   V_{diode} is the voltage drop across a recirculation diode;
   ΔVₛₜₐₜ is the voltage drop across the stator windings of the electrical machine.

In order to take in consideration non-linearities caused by magnetic saturation, leakage fluxes and edge effects of temperature-magnetic flux relationship, moreover, to neglect the voltage drops across diodes and electrical machine windings, an interval for the real speed threshold ωᵣₑₐₗ_{ₜₕ} can be considered:

$$0.92 \frac{{V}_{dc}}{\sqrt{3} [ [ {λ}_{mo} + α ( T - {T}_{0} ) ] + {N}_{rot} {N}_{stat} {I}_{rot} ]} \leq {ω}_{{real}_{th}} \leq 1. 8 \frac{{V}_{dc}}{\sqrt{3} [ [ {λ}_{mo} + α ( T - {T}_{0} ) ] + {N}_{rot} {N}_{stat} {I}_{rot} ]}$$

The interval limits are obtained by considering the UGO effects shown in FIGS. 3a-3c. As can be seen in those figures, if by any means the real speed threshold ωᵣₑₐₗ_{ₜₕ} computed is far distant from the real value the UGO effects increase rapidly with dangerous consequences. Therefore, in order to allow a margin of error in the real speed threshold ωᵣₑₐₗ_{ₜₕ} computation due to non-linearities but at the same time guarantee the system safety, a predetermined error, advantageously an 8% error, is accepted, as this tolerance allows the UGO effects to be less than 5% of the maximum one possible.

The steps of FIG. 7 can be repeated sequentially, when multiple reconfigurations of the electric machine are considered in series, or in parallel, when multiple reconfigurations of the electric machine are considered in parallel.

FIG. 8 shows a block diagram of the steps of the reconfiguration method of the present invention when executed in parallel.

In a first step 200 a first, second, . . . , n^{th} real speed threshold ω_{real_th1}, ω_{real_th2}, . . . , ω_{real_thn} are evaluated (or determined) in real-time manner as here above detailed, then, in step 202, it is checked if a current angular speed ω is greater than the real speed thresholds ω_{real_th1}, ω_{real_th2}, . . . , ω_{real_thn}, respectively.

In positive case, in step 204 no reconfiguration is performed, and the method can start again at step 200. In negative case, in step 206, the current configuration of the electric machine is determined in manner per se known and finally, in step 208, a reconfiguration decision method per sé known is selected.

After that, in step 210, it is decided whether to reconfigure the electric machine or not and, in positive case, in step 212, the reconfiguring of the electric machine is performed.

The method can then be repeated in recursive manner.

FIG. 9 shows a graph of two variable thresholds ω_{real_th1} and ω_{real_th2} applied to an electric machine to pass from a first configuration config₁, to a second configuration config₂ and to a third configuration config₃. In a first alert area 300 there is no reconfiguration to or from the first configuration config₁ and the second configuration config₂, while in a second alert area 302 there is no reconfiguration to or from the first configuration config₁.

Clearly, the principle of the invention remaining the same, the embodiments and the details of production can be varied considerably from what has been described and illustrated purely by way of non-limiting example, without departing from the scope of protection of the present as defined in the attached claims.

1. Method for reconfiguring an electric machine including a rotor arranged to rotate with an angular speed (ω), the electric machine being arranged to pass from a first configuration (config₁) to a second configuration (config₂), the method comprising the steps of:
a) determining in real-time a real speed threshold (ω_{real_th}) depending on the current operating condition of the electric machine;
b) checking if the angular speed (ω) of the rotor is greater than said real speed threshold (ω_{real_th});
c) in positive case, no reconfiguration is performed from the first configuration (config₁);
d) in negative case:
d.1) determining the current configuration of the electric machine;
d.2) selecting a reconfiguring decision method;
d.3) deciding whether to reconfigure the electric machine or not and, in positive case, reconfiguring the electric machine.

2. Method according to claim 1, wherein the step of determining the real speed threshold (ω_{real_th}) comprises performing an estimation of the temperature of magnets of the rotor.

3. Method according to claims 1, wherein the steps are repeated sequentially, when multiple reconfigurations of the electric machine are considered in series, or wherein the steps a)-d) are executed in parallel, when multiple reconfigurations of the electric machine are considered in parallel.

4. Method according to claim 3, comprising the steps of:
determining a first, second, . . . , n^{th} real speed threshold (ω_{real_th1}, ω_{real_th2}, . . . , ω_{real_thn});
checking if the angular speed (ω) of the rotor is greater than the real speed thresholds (ω_{real_th1}, ω_{real_th2}, . . . , ω_{real_thn}), respectively,
in positive case, no reconfiguration from or to the first configuration (config₁), the second configuration (config₂), . . . , an n+1^{th} configuration (configₙₜₕ), respectively, is performed;
in negative case:
determining the current configuration of the electric machine;
selecting a reconfiguring decision method;
deciding whether to reconfigure the electric machine or not and, in positive case, reconfiguring the electric machine.

5. Method according to claim 1, wherein the value of the real speed threshold (ω_{real_th}) is determined in the following interval:
$$0.92 \frac{{V}_{dc}}{\sqrt{3} [ [ {λ}_{mo} + α ( T - {T}_{0} ) ] + {N}_{rot} {N}_{stat} {I}_{rot} ]} \leq {ω}_{{real}_{th}} \leq 1. 8 \frac{{V}_{dc}}{\sqrt{3} [ [ {λ}_{mo} + α ( T - {T}_{0} ) ] + {N}_{rot} {N}_{stat} {I}_{rot} ]}$$
wherein:
λₘₒ and T₀ are respectively a reference magnetic flux and a respective reference temperature of the electric machine;
α is the thermal coefficient of a permanent magnet material of magnets of the rotor;
T is the magnet temperature;
Nᵣₒₜ and Nₛₜₐₜ are respectively the number of turns of windings on the rotor and the number of turns of windings on a stator of the electric machine;
Iᵣₒₜ is the current flowing in the rotor windings;
V_{dc} is a supply voltage of the electric machine.
